(19) United States
(12) Patent Application Publication
(10) Pub. No.: US 2005/0167168 A1
(43) Pub. Date: Aug. 4, 2005

(54) Vehicle and vehicle suspension system

(76) Inventor: Michael Roydon Puzey, Randburg (ZA)

Correspondence Address: YOUNG & THOMPSON, 745 SOUTH 23RD STREET, 2ND FLOOR, ARLINGTON, VA, 22202, US

(21) Appl. No.: 10/765,852

(22) Filed: Jan. 29, 2004

(51) Int. Cl. B60K 1/00

(52) U.S. Cl. 180/65.1

(57) ABSTRACT

A scooter with a rear wheel suspension which acts between a chassis of the scooter and a support and which is pivotally attached to the chassis. The suspension includes a damper and a coil spring of adjustable compression and is placed under increasing load, with a progressively increasing load/deflection characteristic, when the chassis moves downwardly relatively to the rear wheel.

### BACKGROUND OF THE INVENTION

This invention relates to a vehicle such as a small scooter or other multi-wheeled vehicle and more particularly is concerned with a suspension system suitable for use with this type of vehicle.

Small two-wheeled scooters have become increasingly popular. Such scooters, which are driven by a suitable prime mover eg. a gasoline (petrol) engine, are increasing in design sophistication and capabilities. This has led to a demand for a vehicle which is suitable for off-road use or which can be used in a sporting or “extreme” application. This in turn has led to a requirement for an improved suspension arrangement which is of a robust nature and which can be offered at a relatively low cost, for this type of vehicle.

### SUMMARY OF INVENTION

The invention provides a vehicle which includes a chassis, at least first and second ground-engaging wheels, a support which is mounted to the chassis for pivotal movement, relatively to the chassis, to a limited extent, the first wheel including a first axle whereby the first wheel is rotatably mounted to the support, a first shock-absorbing structure with a first mounting point at which the first shock-absorbing structure is secured to the chassis or to the support, and a second mounting point, a lever mechanism with a first attachment point, at which the mechanism is pivotally secured to the chassis, and a second attachment point at which the mechanism is pivotally connected to the second mounting point, and at least one link which is connected at a first connection point to the lever mechanism and at a second connection point to the support.

The first wheel may be driven by means of a prime mover which is mounted to the support and which is pivotally movable, relatively to the chassis, together with the support.

The first mounting point may be closer to the first axle than the second mounting point.

The spacing between the first connection point and the second attachment point may be less than the spacing between the first connection point and the first attachment point.

The arrangement may be such that, when the chassis is moved downwardly relatively to the first wheel, the second mounting point is moved towards the first mounting point against a damping force which is generated by the first shock-absorbing structure.

The first shock-absorbing structure may be of any appropriate nature but preferably includes a first hydraulic or pneumatic damper and a first spring which may be a gas-type spring eg. an air cylinder, a spring made of any suitable material eg. a metallic coil spring or a spring made from one or more elastomeric (eg. polyurethane or rubber) components. The coil spring may be mounted concentrically to the hydraulic damper and extend circumferentially around the damper.

The link may be arranged so that when the chassis moves downwardly relatively to the first wheel the link is placed in tension and thereby exerts a force on the lever mechanism which causes the lever mechanism to rotate. A similar effect can however be obtained by arranging the link so that it is placed under compression as the chassis moves downwardly relatively to the wheel. Again the lever mechanism is caused to rotate against a force which is exerted by the first shock-absorbing structure.

The first shock-absorbing structure may include a device for exerting a compressive force of variable magnitude on the first coil spring. This device may take on any appropriate form but conveniently is provided by a nut or similar component which is threadedly engaged with a thread on an outer surface of the hydraulic damper and which bears against one end of the coil spring.

The chassis may include a footboard and at least a greater part of the first shock-absorbing structure may be positioned below the footboard.

The vehicle may include a steering column which is mounted for pivotal movement, about an upwardly extending axis, relatively to the chassis, a fork assembly, a linkage mechanism which connects the fork assembly to the steering column and which allows reciprocating movement of the fork assembly relatively to the steering column, the second wheel including a second axle whereby the second wheel is rotatably mounted to the fork assembly, and a second shock-absorbing structure which is mounted to dampen reciprocating movement of the fork assembly relatively to the steering column.

The linkage mechanism may include an upper link which is pivotally connected to the steering column and to the fork assembly, and a lower link which is pivotally connected to the steering column and to the fork assembly.

The first and second links may be substantially parallel with substantially equal spacing between their respective pivot points. This arrangement ensures that the fork assembly moves in a straight line up and down, relatively to the steering column, as the second wheel moves over uneven ground. This geometrical arrangement is however not essential for the length of the upper link (ie. the distance between its pivot points) may vary relatively to the length of the lower link. By changing the actual length of each link, and the relative lengths of the upper and lower links, different types of movement of the fork assembly result with the second shock-absorbing structure generating different characteristics of movement versus load.

The second shock-absorbing structure may have a first fixing point whereby the second shock-absorbing structure is secured to one of the links and a second fixing point whereby the second shock-absorbing structure is secured to the fork assembly.

The first fixing point may be secured to the lower link. The first fixing point may be spaced from a pivot point at which the lower link is connected to the fork assembly and this pivot point may be positioned between the first fixing point and a second pivot point at which the lower link is connected to the steering column.

The second shock-absorbing structure may be of any suitable kind but, as for first spring, preferably includes a second hydraulic damper and a second coil spring which may be a gas-type spring eg. an air cylinder, a spring made of any suitable material eg. a metallic coil spring or a spring made from one or more elastomeric (eg. polyurethane or rubber) components.

The vehicle may include a base assembly to which the steering column is attached, which is mounted to the chassis and which is pivotally movable between a first position at which the steering column is an operative road-going mode and a second position at which at least part of the steering column overlies the chassis in a storage mode, and a locking member which is operable, according to requirement, releasably to lock the base assembly in the first position or in the second position.

### BRIEF DESCRIPTION OF THE DRAWINGS

The invention is further described by way of example with reference to the accompanying drawings in which:

FIG. 1 is a side view of a vehicle according to the invention with some of its components which are not required for an understanding of the invention removed in order to simply the drawing;

FIG. 2 is a perspective view of a rear end of the vehicle of FIG. 1, again with certain components removed;

FIG. 3 is a perspective view of a front end of the vehicle of FIG. 1;

FIG. 4 is an enlarged side view of a modified suspension system used on a front wheel of the vehicle; and

FIG. 5 is a view from the front of the suspension system shown in FIG. 4.

### DESCRIPTION OF PREFERRED EMBODIMENTS

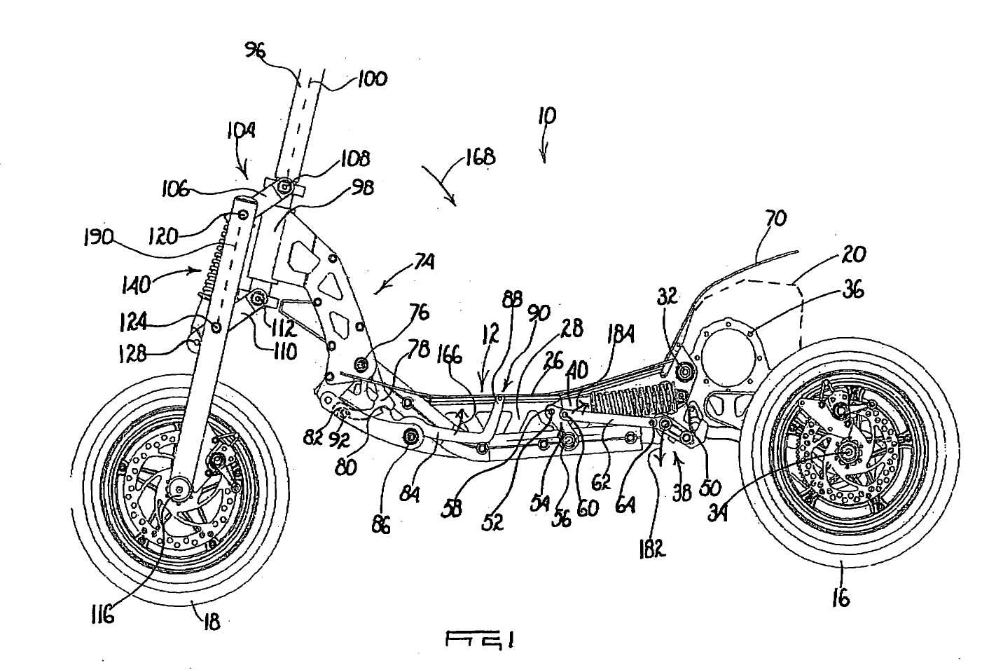

FIG. 1 of the accompanying drawings Illustrates a vehicle 10 which is in the nature of a small scooter which has a chassis 12 and first and second ground-engaging wheels, namely a rear wheel 16 and a front wheel 18 secured to the chassis. The rear wheel is driven by a small gasoline (petrol) engine 20 which is shown in dotted outline in FIG. 1. Alternatively the engine could be replaced by an electric motor which is driven by means of a battery, not shown. The engine 20 works through a gearbox (not shown) of conventional construction and imparts drive to the rear wheel by means of a belt or chain, not shown. These aspects are largely conventional and for this reason are not being described in detail.

The chassis 12 includes a footboard 26 with two underlying plates 28 which provide reinforcing structure to the chassis. In FIG. 1 one of the side plates (the side plate closer to the viewer) has been removed to illustrate more clearly principles of construction.

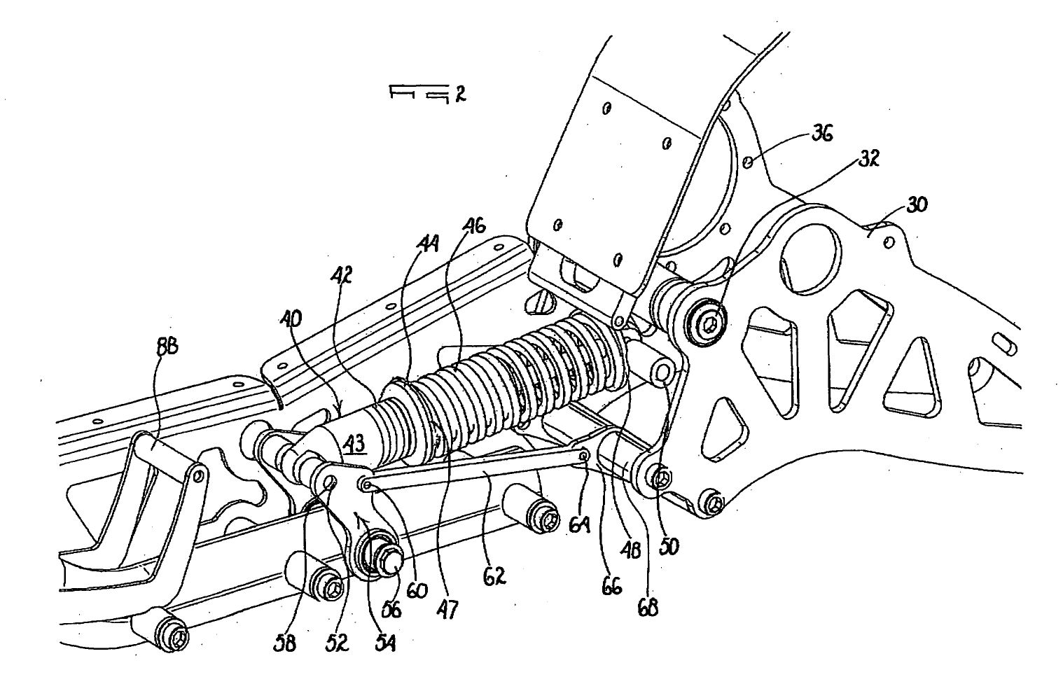

A support 30, comprising suitably shaped plates (see FIG. 2) is mounted to the chassis for limited pivotal movement relatively to the chassis about a point 32. The rear wheel 16 has a first axle 34 which is attached to the support in a known manner. The engine 20 (shown in dotted outline) is also attached to the support by means of bolts which are engaged with various mounting holes 36 in the support.

A first shock-absorbing structure 38 is fixed between the chassis and the support 30. The shock-absorbing structure 38 includes a first hydraulic damper 40 which, as shown in FIG. 2, has a thread 42 formed in an external surface of a cylinder 43 and a nut 44 is engaged therewith. A coil spring 46 which is concentrically mounted to the damper and which partly surrounds the cylinder 44. The nut 44 bears against a washer 47 at a lower side of the spring and an upper end of the spring bears against a plate 48 which is adjacent a first mounting point 50 at which the structure 38 is attached to the chassis 12. A second mounting point 52 is formed at a remote end of the damper 40. A lever mechanism 54 has a first attachment point 56 at which the lever is pivotally secured to the chassis and a second attachment point 58 which is pivotally connected to the second mounting point 52. A first connection point 60 is provided on the lever mechanism between the attachment points 56 and 58. A link 62 is pivotally connected, at one end, to the first connection point 60 and at an opposing end is pivotally connected at a second connection point 64 to a projecting arm 66 which extends from a brace 68 on the support 30, see FIG. 2. These aforegoing constructional details have been shown and described as being on one side of the damper 40 but can be duplicated on an opposing side of the damper.

The distance between the first connection point 60 and the first attachment point 56 is less than the distance between the first and second attachment points 56 and 58. This creates a slight mechanical advantage in favour of the first shock-absorbing structure 38 over the link 62 which means that, for the lever mechanism 54 to be balanced, the force exerted by the link on the lever mechanism must be greater than the force exerted at the time, on the lever mechanism, by the first shock-absorbing structure. It is to be noted that the first shock-absorbing structure 38 is primarily located below the footboard 26 and thus can function without impeding the feet of a user of the vehicle, and vice versa.

A mudguard or similar shield 70 extends upwardly from the footboard 26 over a portion of the rear wheel 16.

A base assembly 74 extends upwardly from a forward end of the chassis. The base assembly is mounted to the chassis 12 at a pivot point 76. The assembly includes a plate 78 which has first and second notches 80 and 82 respectively which face downwardly. A spring-loaded locking member 84 is fixed to the chassis and is pivotally movable relatively thereto about a pivot point 86. One end 88 of the locking member is accessible through a hole 90 in the footboard 26. The locking member has a catch 92 at an end which is remote from the end 88. The catch is engageable, according to requirement, with the formation 80 or the formation 82.

A steering column 96 is attached to the base assembly and extends through a bush 98 which permits rotational movement of the column, to a limited extent, about an upwardly extending axis 100 which is aligned with the length of the column. A linkage mechanism 104 is attached to the steering column. The linkage mechanism includes an upper link 106 which is attached at a pivot point 108 to the column and a lower link 110 which is attached at a pivot point 112 to a lower end of the column which extends from the bush 98.

The second wheel 18 has a second axle 116 which is attached, in a known manner, to a fork assembly 118. The upper link 106 is pivotally connected to the fork assembly at a pivot point 120 while the lower link is pivotally connected to the fork assembly at a pivot point 124.

The lower link has a first fixing point 128 which is at one end of the lower link so that the pivot point 124 is between the pivot point 112 and the fixing point 128.

A second shock-absorbing structure 140 is attached to the fork assembly and the lower link. The shock-absorbing structure 140 is similar in many respects to the first shock-absorbing structure and includes a second hydraulic damper 142 and a second coil spring 144 which is mounted concentrically to the damper 142, partly surrounding the damper. The degree of compression in the coil spring can be adjusted by means of a nut 146 which is threadedly engaged with thread 148 on an outer surface of a cylinder 150 of the damper. An upper end of the shock-absorbing structure is attached to the fork assembly at a second fixing point 160 which may be coincident with the pivot point 120 but this is not necessarily the case. A lower end of the second shock-absorbing structure is pivotally attached to the first fixing point 128.

FIG. 1 illustrates the steering column 96 and the front wheel in an operative road-going mode wherein the steering column extends substantially vertically. The column is kept in this position by means of the catch 92 which is engaged with the formation 82. If the locking member 84 is raised, it pivots about the pivot point 86 in the direction of an arrow 166 and the catch 92 disengages from the formation 82. The steering column can then be rotated downwardly, as is indicated by an arrow 168, about the pivot point 76 to a storage position at which the steering column partly overlies the foot board. A stage is reached at which the catch 92 engages with the formation 80 and the steering column is then kept in the storage mode. It is therefore relatively easy to change the configuration of the scooter from a road-going mode or to a storage mode, and vice versa.

Referring in particular to FIGS. 1 and 2 if the rear wheel 16 encounters rough ground or shock loading then there is a tendency for the chassis 12 to move downwardly and for the rear wheel 16 to pivot upwardly together with the support 30 and the engine 20 about the pivot point 32. This pivotal movement is dampened and controlled by the first shock-absorbing structure 38. As the support 30 pivots upwardly the second connection point 64 is pivoted downwardly, as it is indicated by an arrow 182 and the lever mechanism 54 is then rotated in a clockwise direction 184 about the first attachment point 56. The shock-absorbing structure 38 is placed under compression with the hydraulic damper and coil spring exerting a damping force.

With the first connection point 60 and the s cond attachment point 58 in the FIG. 1 position, ie. with these points substantially aligned with the length of the link 62, the shock-absorbing structure displays a relatively soft suspension characteristic. However as the lever mechanism 54 rotates further in the direction of the arrow 184 the second attachment point 58 becomes further displaced from the line between the first attachment point 60 and the second attachment point 64 and the structure 38 develops a harder suspension characteristic. It is to be noted that the damping force of the damper 40 is not normally adjustable whereas the compression force exerted on the spring 42 is adjustable by means of the nut 44 which can be rotated in either direction along the thread 42 in the cylinder. This adjustment can be done with ease and it is therefore possible for a user to adjust the suspension characteristic of the structure 38, according to requirement.

The progressive shock-absorbing characteristic which results from the rotating lever mechanism 54 means that a relatively soft and comfortable ride results when the vehicle moves over a relatively smooth surface whereas, if the surface is rough or if the vehicle is moving at speed the lever mechanism 54, as noted, tends to rotate to a greater extent and this produces a harder or stiffer suspension characteristic.

The structure 38 is pivotally attached to the chassis at the mounting point 50. It is possible, though, to attach the mounting point 50, at one end of the structure, to the support 30 but preferably at a location which is close to, and slightly above, the position of the point 50 as shown in FIG. 1. When the support moves upwardly relatively to the footboard, the structure 38 is thereby placed under compression and this effect is intensified by the action of the link 62 which is placed under tension at the same time. In another variation the link 62 is connected to the support 30 “above” the point 50 so that it is placed under compression as the support moves relatively to the footboard. The force variation is transmitted to the structure 38 which is thereby again placed under compression.

When the front wheel 18 strikes the ground under impact then the chassis 12 tends to move downwardly. The steering column 96 also moves downwardly with its movement being controlled by the linkage mechanism 104 which restrains the column to move about the pivot points 120 and 124. The first fixing point 128 on the lower link moves upwardly and the second shock-absorbing structure 140 is placed under compressive force which acts to dampen the relative movement between the chassis and the front wheel.

The suspension characteristic of the second shock-absorbing structure 140 is also adjustable, within limits, by rotating the nut 146 along the threaded exterior 148 of the damper 142.

In the configuration shown in FIG. 1 the spacing between the pivots points 108 and 120 is the same as the spacing between the pivot points 112 and 124 on the lower link. Thus the fork assembly 118 tends to move in a straight line, which is coincident with its longitudinal axis 190, when the front wheel 18 moves over uneven ground. This however is not necessarily the case for the relatively lengths of the links, and the spacing between the respective pivot points, can be altered to provide different ride characteristics.

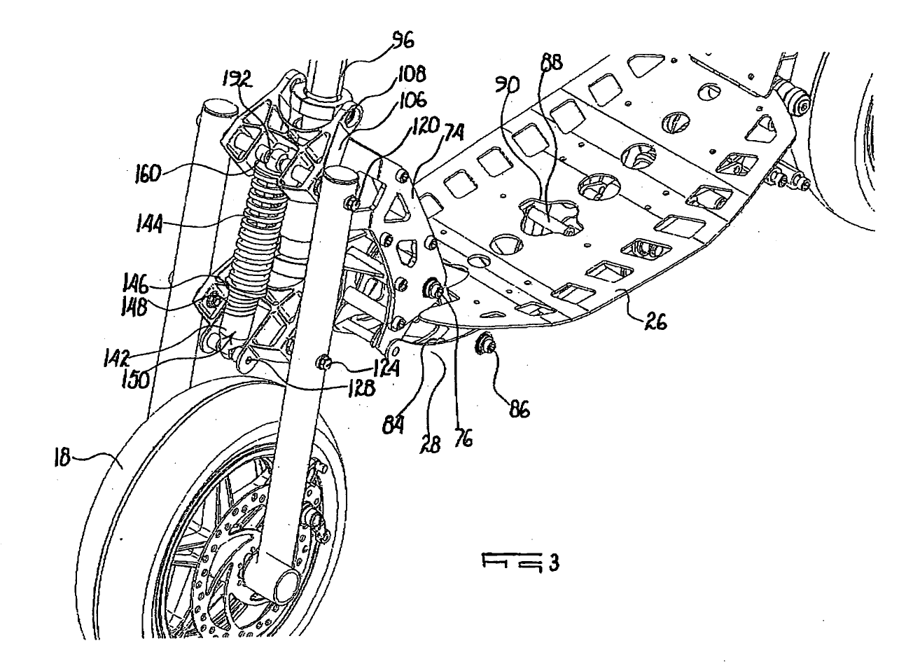

FIG. 3 illustrates that the fixing point 160 is formed by a shaft 192 which passes through the upper link 106, which is of a compound construction, and which forms a fork-shaped aperture into which an upper end of the damper extends. The shaft 192 is also used to fix the link 106 to the fork assembly. Consequently the pivot point 120 is coincident with the second fixing point 160.

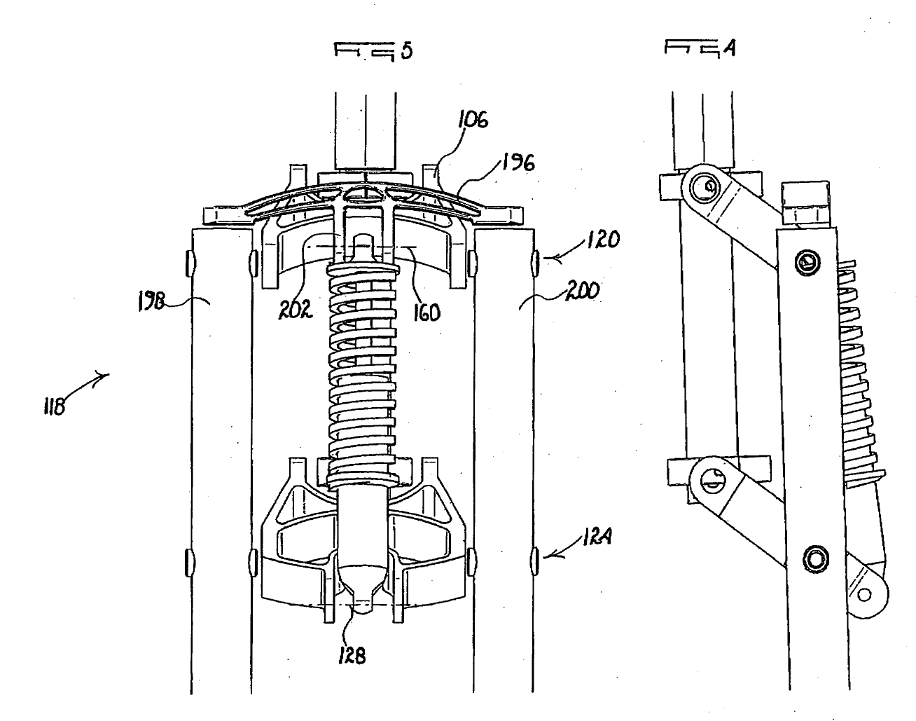

FIGS. 4 and 5 show a different type of structure. The fork assembly 118 can be subjected, in use, to significant forces and, in order to strengthen the fork assembly, a bridging piece 196 is connected to upper ends of fork members 198 and 200 of the fork assembly. The upper link 106 is separately connected to each of the fork members by means of suitable bolts aligned with the fixing point 120. The second fixing point 160 is formed by securing the upper end of the damper to a downwardly depending fork 202 on the bridging piece 196 by means of a suitable bolt (not shown).

The suspension systems which are included in the vehicle of the invention have been found to be highly effective, enabling the vehicle to engage in extreme or acrobatic manoeuvres. As the stiffness characteristic of each suspension structure is readily adjustable by a user, according to requirement, where necessary, the vehicle 10 is seated for on-road and off-road use.

1. A vehicle which includes a chassis, at least first and second ground-engaging wheels, a support which is mounted to the chassis for pivotal movement, relatively to the chassis to a limited extent, the first wheel including a first axle whereby the first wheel is rotatably mounted to the support, a first shock-absorbing structure with a first mounting point, at which the first shock-absorbing structure is secured to the chassis or to the support, and a second mounting point, a lever mechanism with a first attachment point, at which the mechanism is pivotally secured to the chassis or to the support, and a second attachment point at which the mechanism is pivotally connected to the second mounting point, and at least one link which is connected at a first connection point to the lever mechanism and at a second connection point to the support.

2. A vehicle according to claim 1 wherein the first wheel is driven by means of a prime mover which is mounted to the support and which is pivotally movable, relatively to the chassis, together with the support.

3. A vehicle according to claim 1 wherein the first mounting point is closer to the first axle than the second mounting point.

4. A vehicle according to claim 1 wherein the spacing between the first connection point and the second attachment point is less than the spacing between the first connection point and the first attachment point.

5. A vehicle according to claim 1 wherein, when the chassis is moved downwardly relatively to the first wheel, the second mounting point is moved towards the first mounting point against a damping force which is generated by the first shock-absorbing structure.

6. A vehicle according to claim 1 wherein the first shock-absorbing structure includes a first hydraulic damper and a first coil spring.

7. A vehicle according to claim 6 which includes a device for exerting a compressive force of variable magnitude on the first coil spring.

8. A vehicle according to claim 1 wherein the chassis includes a footboard and at least a greater part of the first shock-absorbing structure is below the footboard.

9. A vehicle according to claim 1 which includes a steering column which is mounted for pivotal movement, about an upwardly extending axis, relatively to the chassis, a fork assembly, a linkage mechanism which connects the fork assembly to the steering column and which allows reciprocating movement of the fork assembly relatively to the steering column, the second wheel including a second axle whereby the second wheel is rotatably mounted to the fork assembly, and a second shock-absorbing structure which is mounted to dampen reciprocating movement of the assembly relatively to the steering column.

10. A vehicle according to claim 9 wherein the linkage mechanism includes an upper link which is pivotally connected to the steering column and the fork assembly, and a lower link which is pivotally connected to the steering column and to the fork assembly.

11. A vehicle according to claim 10 wherein the second shock-absorbing structure has a first fixing point whereby the second shock-absorbing structure is secured to one of the links and a second fixing point whereby the second shock-absorbing structure is secured to the fork assembly.

12. A vehicle according to claim 11 wherein the first fixing point is secured to the lower link.

13. A vehicle according to claim 12 wherein the first fixing point is spaced from a pivot point at which the lower link is connected to the fork assembly.

14. A vehicle according to claim 9 wherein the second shock-absorbing structure includes a second hydraulic damper and a second coil spring.

15. A vehicle according to claim 9 which includes a base assembly, to which the steering column is attached, which is mounted to the chassis and which is pivotally movable between a first position at which the steering column is in an operative road-going mode and a second position at which at least part of the steering column overlies the chassis in a storage mode, and a locking member which is operable, according to requirement, releasably to lock the base assembly in the first position or in the second position.
